(19) United States
(12) Patent Application Publication
(10) Pub. No.: US 2005/0033909 A1
(43) Pub. Date: Feb. 10, 2005

(54) MOTHERBOARD UTILIZING A SINGLE-CHANNEL MEMORY CONTROLLER TO CONTROL MULTIPLE DYNAMIC RANDOM ACCESS MEMORIES

(76) Inventors: Nai-Shung Chang, Taipei Hsien (TW); Chunhung Chen, Taipei Hsien (TW); Wei Lee, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/707,106

(22) Filed: Nov. 20, 2003

(30) Foreign Application Priority Data
Aug. 6, 2003 (TW) 092121551

(51) Int. Cl. G06F 12/00

(52) U.S. Cl. 711/105; 711/115; 711/154

(57) ABSTRACT

A motherboard utilizing a single-channel memory controller to control multiple DRAMs. The motherboard includes a first memory slot, a second memory slot, and a single-channel memory controller. The memory controller is connected to the first memory slot and the second memory slot respectively through a first bus and a second bus.

### BACKGROUND OF INVENTION

1. Field of the Invention

The present invention relates to a motherboard with a single-channel memory controller. In particular, the present invention discloses a motherboard utilizing a single-channel memory controller to control multiple dynamic random access memories.

2. Description of the Prior Art

Please refer to FIG. 1, which is a block diagram of a prior art computer system 10. A central processing unit (CPU) 12 is used for controlling the overall operation of the computer system 10. A north bridge circuit 14 is used for controlling signal transmission between high-speed peripheral devices (a display controller 18 and a memory device 20 for example) and the CPU 12. However, a south bridge circuit 16 is used for controlling signal transmission between low-speed peripheral devices (a hard-disk drive 22 and an input/output device 24 for example) and the north bridge circuit 14. The display controller 18 is used for processing graphics data to generate video signals to drive a monitor (not shown). The memory device 20 is a volatile storage device for keeping volatile data. However, the hard-disk drive 22 is a storage device for keeping non-volatile data. The input/output device 24 is used for receiving signals triggered by a user or for outputting data.

Generally speaking, the north bridge circuit 14 has one memory controlling unit 26 for controlling data storage and data retrieval of the memory device 20. In other words, the memory controlling unit 26 and the corresponding memory device 20 establish a memory accessing system 28. Concerning the computer system 10, it needs the memory accessing system 28 to work normally. For example, codes of an operating system stored by the hard-disk drive 22 are loaded into the memory device 20 through the south bridge circuit 16 and the memory accessing system 28 when the computer system 10 is successfully booted via a prior art power-on-self-test (POST) procedure. Then, the CPU 12 reads the codes of the operating system with the help of the memory accessing system 28, and executes the operating system to manage hardware of the computer system 10 and application software run by the computer system 10. To sum up, operations of computer components are correctly completed through utilizing the memory accessing system 28 to store data in the memory device 20 and retrieve data from the memory device 20.

Please refer to FIG. 2, which is a diagram of a first prior art memory accessing system 30. The memory accessing system 30 includes a memory controller 32 and a plurality of memory slots 34a, 34b, 34c. The memory controller 32 is used for constructing the memory controlling unit 26 shown in FIG. 1. That is, the memory controller 32 is positioned inside the north bridge circuit 14 shown in FIG. 1. The memory slots 34a, 34b, 34c are used for installing memory modules to construct the memory device 20 shown in FIG. 1. For example, the memory slots 34a, 34b, 34c are prior art single inline memory module (SIMM) slots or prior art dual inline memory module (DIMM) slots. It is well-known that a memory module conforming to the SIMM specification has a 32-bit data channel, and a memory module conforming to the DIMM specification has a 64-bit data channel. An input/output port A of the memory controller 32 is electrically connected to corresponding memory data transmission routes 42a, 42b, 42c of the memory slots 34a, 34b, 34c through a memory data bus 36. In addition, one output port B of the memory controller 32 is electrically connected to corresponding memory address transmission routes 44a, 44b, 44c of the memory slots 34a, 34b, 34c through a memory address bus 38, and another output port C of the memory controller 32 is electrically connected to corresponding control signal transmission routes 46a, 46b, 46c of the memory slots 34a, 34b, 34c through a control signal bus 40. The memory data bus 36, the memory address bus 38, and the control signal bus 40 are respectively used for transferring memory data, memory addresses, and control signals associated with the installed memory modules. For instance, the control signals include a clock enable (CKE) signal, a chip select (CS) signal, a row address strobe (RAS) signal, a column address strobe (CAS) signal, a write enable (WE) signal, etc.

It is well-known the memory controller 32 shown in FIG. 2 is a single-channel memory controller, that is, the memory controller 32 uses the same buses 36, 38, 40 for delivering memory data, memory addresses, and control signals to different memory modules. However, the operating clock of the CPU 12 now corresponds to a higher frequency than before, and the CPU 12 is capable of processing a great amount of data. Therefore, the memory accessing system 30 adopting the single-channel architecture is unable to satisfy the user who asks for better data processing performance. In order to improve performance of the computer system 10, a dual-channel architecture is applied to boost performance of the memory device 20.

Please refer to FIG. 3, which is a diagram of a second prior art memory accessing system 50. A memory controller 52a has an input/output port A₁, an output port B₁, and an output port C respectively connected to transmission routes 62a, 62b, 64a, 64b, 66a, 66b through a memory data bus 56a, a memory address bus 58a, and a control signal bus 60a for controlling the memory slots 54a, 54b. In addition, another memory controller 52b has an input/output port A₂, an output port B₂, and an output port C₂ respectively connected to transmission routes 62c, 64c, 66c through a memory data bus 56b, a memory address bus 58b, and a control signal bus 60b for controlling the memory slots 54c.

When the memory accessing system 50 enables the dual-channel architecture, it is well-known that the memory controllers 52a, 52b are activated to control memory modules inserted into different memory slots. As shown in FIG. 3, the memory controller 52a is electrically connected to both of the memory slots 54a, 54b, and the memory controller 52c is electrically connected to the memory slot 54c. Therefore, in order to enable the dual-channel architecture, one memory module has to be inserted into either the memory slot 54a or the memory slot 54b, and another memory module has to be inserted into the memory slot 54c. The memory controllers 52a, 52b work individually. If the memory data buses 56a, 56b are 64-bit buses, the actual memory data bus between the memory controlling unit 26 and the memory device 20 shown in FIG. 1 is equivalent to a 128-bit bus with the help of the activated dual-channel architecture. In other words, data accessing performance of the memory device 20 is greatly improved.

The memory accessing system 50 also can enable a single-channel architecture. That is, only one of the memory controllers 52a, 52b is activated. For instance, when the memory controller 52a is selected, two memory modules can be inserted into the memory slots 54a, 54b. Therefore, the installed memory modules have to share the same channels such as the memory data bus 56a, the memory address bus 58a, and the control signal bus 60a.

As mentioned above, the layout of a motherboard merely supporting the single-channel architecture can not directly support the dual-channel architecture without modifying the original layout design. However, before the dual-channel architecture completely replaces the single-channel architecture, the demand for motherboards only supporting the single-channel architecture still exists. Therefore, in order to cut down the research cost and the development cost, it is necessary for the motherboard manufacturer to design a motherboard having a circuit layout that is suitable for installing either a single-channel memory controller or a dual-channel memory controller.

### SUMMARY OF INVENTION

It is therefore a primary objective of this invention to provide a motherboard utilizing a single-channel memory controller to control multiple dynamic random access memories.

Briefly summarized, the preferred embodiment of the present invention provides a motherboard having a first memory slot, a second memory slot, and a single-channel memory controller electrically connected to the first memory slot and the second memory slot respectively through a first bus and a second bus.

The present invention also provides a computer system having a first dynamic random access memory, a second dynamic random access memory, and a single-channel memory controller connected to a first bus and a second bus respectively for controlling the first dynamic random access memory and the second dynamic random access memory.

In addition, the present invention provides a package having a single-channel memory controller, a plurality of first external contacts electrically connected to a memory data input/output port, a memory address output port, and a control signal output port of the single-channel memory controller. A plurality of second external contacts are electrically connected to the memory data input/output port, the memory address output port, and the control signal output. The first external contacts are used for connecting a first memory bus, and the second external contacts are used for connecting a second memory bus.

It is an advantage of the present invention that a motherboard originally corresponding to a dual-channel architecture is transformed into a motherboard running a single-channel architecture with all of the memory slots capable of being simultaneously utilized to install memory modules. Even if the motherboard originally has a circuit layout for a dual-channel architecture, a motherboard manufacturer does not need to re-design the circuit layout of the motherboard to let all of the memory slots be available to the single-channel architecture.

These and other objectives of the present invention will no doubt become obvious to those of ordinary skill in the art after reading the following detailed description of the preferred embodiments, which are illustrated in the various figures and drawings.

### BRIEF DESCRIPTION OF DRAWINGS

FIG. 1 is a block diagram of a prior art computer system.

FIG. 2 is a diagram of a first prior art memory accessing system.

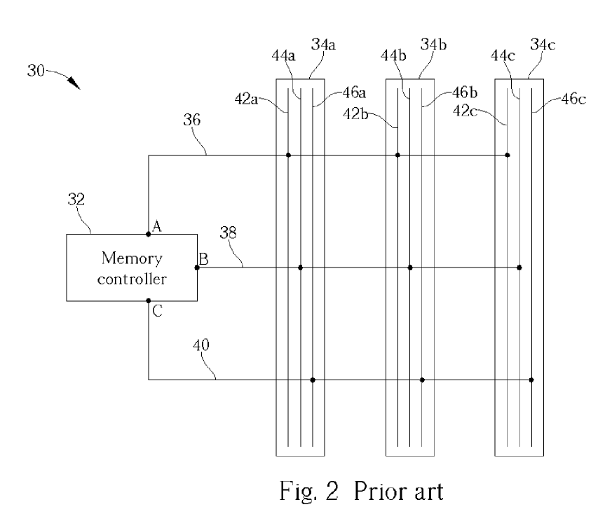

FIG. 3 is a diagram of a second prior art memory accessing system.

FIG. 4 is a diagram of a memory accessing system according to the present invention.

### DETAILED DESCRIPTION

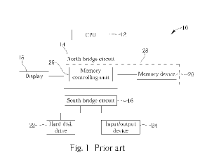

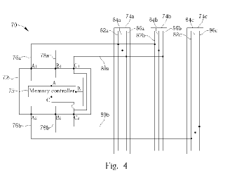

Please refer to FIG. 4, which is a diagram of a memory accessing system 70 according to the present invention. The memory accessing system 70 is applied on the computer system 10 shown in FIG. 1. Because the operation of the computer system 10 has been described above, the repeated description for the computer system 10 is skipped without affecting the technical disclosure of the present invention. In the preferred embodiment, the memory accessing system 70 has a memory controlling unit 72 and a plurality of memory slots 74a, 74b, 74c. Memory modules can be installed into the memory slots 74a, 74b, 74c to construct the memory device 20 shown in FIG. 1. For example, the memory slots 74a, 74b, 74c are single inline memory module (SIMM) slots or dual inline memory module (DIMM) slots. Therefore, a memory module conforming to the SIMM specification has a 32-bit data channel, and a memory module conforming to the DIMM specification has a 64-bit data channel.

An input/output port A₁ of the memory controlling unit 72 is electrically connected to corresponding memory data transmission routes 82a, 82b of the memory slots 74a, 74b through a memory data bus 76a. An output port B₁ of the memory controlling unit 72 is electrically connected to corresponding memory address transmission routes 84a, 84b of the memory slots 74a, 74b through a memory address bus 78a, and an output port C₁ of the memory controlling unit 72 is electrically connected to corresponding control signal transmission routes 86a, 86b of the memory slots 74a, 74b through a control signal bus 80a. In addition, an input/output port A₂ of the memory controlling unit 72 is electrically connected to a corresponding memory data transmission route 82c of the memory slot 74c through a memory data bus 76b, an output port B of the memory controlling unit 72 is electrically connected to a corresponding memory address transmission route 84c of the memory slot 74c through a memory address bus 78b, and an output port C₂ of the memory controlling unit 72 is electrically connected to a corresponding control signal transmission route 86c of the memory slot 74c through a control signal bus 80b. As shown in FIG. 4, the buses 76a, 78a, 80a on the motherboard are viewed as a first memory bus corresponding to one channel, and the buses 76b, 78b, 80b on the motherboard are viewed as a second memory bus corresponding to another channel.

The memory data buses 76a, 76b are used for delivering memory data outputted from the memory controlling unit 72 to the memory modules installed into the memory slots 74a, 74b, 74c, and are used for transferring memory data retrieved from the memory modules installed into the memory slots 74a, 74b, 74c to the memory controlling unit 72. The memory address buses 78a, 78b are used for delivering memory addresses outputted from the memory controlling unit 72 to the memory modules installed into the memory slots 74a, 74b, 74c. In addition, the control signal buses 80a, 80b are used for transferring control signals generated from the memory controlling unit 72 to the memory modules installed into the memory slots 74a, 74b, 74c. For instance, the control signals include a clock enable (CKE) signal, a chip select (CS) signal, a row address strobe (RAS) signal, a column address strobe (CAS) signal, a write enable (WE) signal, etc. In the preferred embodiment, the memory controlling unit 72 only includes one memory controller 75. Therefore, with regard to a circuit layout of a motherboard supporting a dual-channel architecture, the preferred embodiment is capable of making use of all memory slots 74a, 74b, 74c for a single-channel architecture. The principle of the preferred embodiment is described as follows.

As mentioned above, the memory controlling unit 72 is positioned within a north bridge circuit. It is well-known that a die corresponding to the north bridge circuit is positioned in a package according to a predetermined packaging technology. For example, the die corresponding to the north bridge circuit is positioned inside a ball grid array (BGA) package. That is, the die is loaded on a substrate, and a bottom of the substrate has a plurality of solder balls functioning as contacts used for connecting corresponding points on a motherboard. In addition, the contacts or so-called bailouts are electrically connected to the die for transmitting operating voltages and signals of the north bridge circuit. The input/output ports A₁, A₂, output ports B₁ B₂, and the output ports C₁, C₂ respectively correspond to bailouts of the BGA package. Therefore, when the BGA package corresponding to the north bridge circuit is installed on a motherboard, the input/output ports A₁, A₂, output ports B₁, B₂, and the output ports C₁, C₂ are capable of being electrically connected to the memory data buses 76a, 76b, the memory address buses 78a, 78b, and the control signal buses 80a, 80b positioned on the motherboard.

Suppose that the memory data buses 76a, 76b are 64-bit buses. Therefore, the memory data bus 76a has a plurality of transmission lines D₀-D₆₃, and the memory data bus 76b has a plurality of transmission lines D₀-D″₆₃. In addition, the input/output port A has 64 bailouts connected to the transmission lines D₀-D₆₃, and the input/output port A also has 64 bailouts connected to the transmission lines D₀-D₆₃. Within the substrate of the package, the input/output port A₁ is electrically connected to the input/output port A₂. In other words, a bailout corresponding to a transmission line D″ₙ is electrically connected to a bailout corresponding to a transmission line Dₙ (0
≦
n
≦
   63). Similarly, the connection rule for the bailouts corresponding to the output ports B₁, B₂ and the bailouts corresponding to the output ports C₁, C₂ is identical to the above-mentioned rule for connecting the input/output port A₁, A₂.

Please note that the circuit layout of the motherboard associated with the memory slots 74a, 74b, 74c shown in FIG. 4 corresponds to a dual-channel architecture. That is, contacts on the motherboard corresponding to the input/output port A₁, the output port B₁, and the output port C are originally used for connecting a memory controller, and contacts on the motherboard corresponding to the input/output port A₁₂, the output port B₂, and the output port C₂ are originally used for connecting another memory controller. In other words, according to the circuit layout corresponding to the dual-channel architecture, the memory controlling unit 72 ought to have two memory controllers. However, in the preferred embodiment, only one memory controller 75 is positioned inside the memory controlling unit 72. In addition, both of the input/output ports A₁, A₂ are connected to an input/output port of the memory controller 75, both of the output ports B₁, B₂ are connected to an output port B of the memory controller 75, and both of the output ports C₁, C₂ are connected to an output port C of the memory controller 75 with the allocation of bailouts on the claimed package mating with the allocation of contacts on the motherboard.

As mentioned above, the die corresponding to the north bridge circuit is positioned inside a package according to a predetermined packaging technology. In other words, the die includes the circuitry of the memory controller 75. In the preferred embodiment, the bailouts of the input/output ports A₁, A₂ are electrically connected through traces within the substrate of the package, and the input/output ports A₁, A₂ are also electrically connected to the input/output port A through the traces routed in the substrate of the package. By the same means, the output ports B₁, B are electrically connected to the output port B, and the output ports C₁, C₂ are electrically connected to the output port C.

Suppose that memory modules are simultaneously installed into all of the memory slots 74a, 74b, 74c. As shown in FIG. 4, the memory address outputted from the output port B of the memory controller 75 is delivered to memory address transmission routes 84a, 84b, 84c of the memory slots 74a, 74b, 74c through the output ports B₁, B₂ and the corresponding memory address buses 78a, 78b. In addition, the control signal outputted from the output port C of the memory controller 75 is delivered to control signal transmission routes 86a, 86b, 86c of the memory slots 74a, 74b, 74c through the output ports C₁, C₂ and the corresponding control signal buses 80a, 80b. Therefore, control circuits (row decoder, column decoders, writing circuits, or sense amplifiers for example) inside the memory modules installed into the memory slots 74a, 74b, 74c can store data into memory cells of the memory modules or read data from memory cells of the memory modules according to the control signals received from the control signal transmission routes 86a, 86b and memory addresses received from the memory address transmission routes 84a, 84b.

Concerning the data storage, the memory controller 75 outputs memory data out of the input/output port A, and the memory data are further delivered to memory data transmission routes 82a, 82b of the memory slots 74a, 74b and the memory data transmission route 82c of the memory slot 74c through bailouts of the input/output ports A₁, A₂. With regard to the data retrieval, the memory data retrieved from the memory modules are delivered to bailouts of the input/output ports A₁, A₂ through the memory data buses 76a, 76b. Because both of the input/output ports A₁, A₂ are connected to the identical input/output port A, the memory data retrieved from the memory modules, therefore, are passed to the memory controller 75.

As mentioned above, the circuit layout for the memory slots 74a, 74b, 74c positioned on the motherboard corresponds to the dual-channel architecture. Therefore, the memory data bus 76a, the memory address bus 78a, and the control signal bus 80a are respectively connected between the memory slots 74a, 74b and bailouts of the input/output port A₁, the output port B₁, and the output port C₁, and the memory data bus 76b, the memory address bus 78b, and the control signal bus 80b are respectively connected between the memory slots 74b and ball-outs of the input/output port A₂, the output port B₂, and the output port C₂. For the package of the north bridge circuit, the input/output ports A₁, A₂, the output ports B₁, B₂, and the output ports C₁, C₂ correspond to different bailouts. However, The preferred embodiment utilizes a single memory controller 75 on a motherboard with a circuit layout originally supporting a dual-channel architecture.

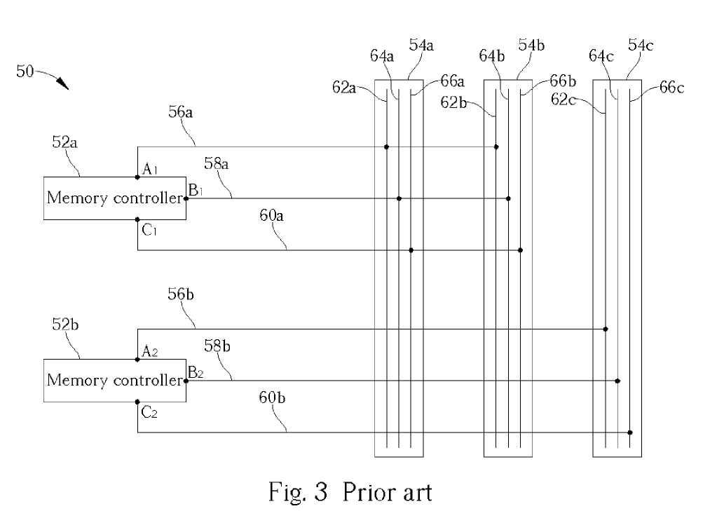

Different bailouts corresponding to the input/output ports A₁, A₂ are connected together through traces routed within the substrate of the package. Similarly, different bailouts corresponding to the input/output ports B₁, B₂ are connected together through traces routed within the substrate of the package, and different bailouts corresponding to the input/output ports C₁, C₂ are connected together through traces routed within the substrate of the package. For the memory controller 75, the original configuration of the memory slots 74a, 74b, 74c on the motherboard is equivalent to a single-channel architecture after the claimed memory controlling unit 72 is installed, and the memory controller 75 is capable of controlling memory modules installed into the memory slots 74a, 74b, 74c according to the single-channel architecture. Therefore, when the memory accessing system 70 enables the single-channel architecture, all memory slots 74a, 74b, 74c on the motherboard can be used for installing memory modules. Please note that if the memory controlling unit 72 has two independent memory controllers, the memory slots 74a, 74b, 74c can be used for activating the dual-channel architecture. That is, from the circuit design shown in FIG. 3, it is obvious that the circuit layout for memory slots 74a, 74b, 74c positioned on the motherboard can successfully enable the dual-channel architecture.

As mentioned above, even if the circuit layout associated with the memory slots 74a, 74b, 74c on the motherboard is designed for the well-known dual-channel architecture, the present invention discloses that a north bridge circuit having a single memory controller 75 is capable of simultaneously controlling all memory modules installed into the memory slots 74a, 74b, 74c through appropriate traces routed for the memory controlling unit 72 inside the corresponding package. That is, the memory controller 75 now adopts the single-channel architecture to connect the memory slots 74a, 74b, 74c. Therefore, the manufacturer of the motherboard manufactures motherboards supporting the dual-channel architecture according to the circuit layout shown in FIG. 3. However, the preferred embodiment, as shown in FIG. 4, installs the memory controlling unit 72, which has one memory controller 75, onto the motherboard corresponding to the circuit layout shown in FIG. 3.

In addition, the allocation of contacts on the motherboard for the input/output ports A₁, A₂, the output ports B₁, B₂, and the output ports C₁, C₂ is unchanged. Through utilizing traces routed in the substrate of the package to build a connection between the input/output ports A₁, A₂, a connection between the output ports B₁, B₂, and a connection between the output ports C₁, C₂, the memory slots 74a, 74b, 74c can be used for installing memory modules that work according to the single-channel architecture. In other words, all of the memory slots can be fully utilized for the enabled single-channel architecture when a new north bridge circuit, which has the claimed memory controlling unit and has bailouts compatible with the original allocation of contacts on the motherboard, replaces the original north bride circuit. Therefore, the motherboard manufacturer does not need to re-design the circuit layout of the motherboard.

1. A motherboard comprising:
at least a first memory slot;
at least a second memory slot; and
a single-channel memory controller electrically connected to the first memory slot and the second memory slot through a first bus and a second bus.

2. The motherboard of claim 1 wherein each of the first and second buses is used for transferring memory data, memory addresses, and control signals.

3. The motherboard of claim 1 wherein the single-channel memory controller comprises:
a memory data input/output port for outputting a memory data to the first and second memory slots through the first and second buses;
a memory address output port for outputting a memory address to the first and second memory slots through the first and second buses; and
a control signal output port for outputting a control signal to the first and second memory slots through the first and second buses.

4. The motherboard of claim 1 wherein the single-channel memory controller is positioned inside a package, and the package comprises:
at least two first external contacts connected to the first and second buses respectively for transferring memory data;
at least two second external contacts connected to the first and second buses respectively for transferring memory addresses;
at least two third external contacts connected to the first and second buses respectively for transferring control signals; and
a plurality of traces electrically connected to the first external contacts and a memory data input/output port of the single-channel memory controller, electrically connected to the second external contacts and a memory address output port of the single-channel memory controller, and electrically connected to the third external contacts and a control signal output port of the single-channel memory controller.

5. A computer system comprising:
at least a first dynamic random access memory;
at least a second dynamic random access memory; and
a single-channel memory controller connected to a first bus and a second bus respectively for controlling the first dynamic random access memory and the second dynamic random access memory.

6. The computer system of claim 5 wherein each of the first and second buses is used for transferring memory data, memory addresses, and control signals.

7. The computer system of claim 5 wherein the single-channel memory controller comprises:
a memory data input/output port for outputting memory data to the first and second memory slots through the first and second buses;
a memory address output port for outputting memory addresses to the first and second memory slots through the first and second buses; and
a control signal output port for outputting control signals to the first and second memory slots through the first and second buses.

8. The computer system of claim 5 wherein the single-channel memory controller is positioned inside a package, and the package comprises:
at least two first external contacts connected to the first and second buses respectively for transferring memory data;
at least two second external contacts connected to the first and second buses respectively for transferring memory addresses;
at least two third external contacts connected to the first and second buses respectively for transferring control signals; and
a plurality of traces electrically connected to the first external contacts and a memory data input/output port of the single-channel memory controller, electrically connected to the second external contacts and a memory address output port of the single-channel memory controller, and electrically connected to the third external contacts and a control signal output port of the single-channel memory controller.

9. A package comprising:
a single-channel memory controller;
a plurality of first external contacts electrically connected to a memory data input/output port, a memory address output port, and a control signal output port of the single-channel memory controller, the first external contacts being used for connecting a first memory bus; and
a plurality of second external contacts electrically connected to the memory data input/output port, the memory address output port, and the control signal output, the second external contacts being used for connecting a second memory bus.

10. The package of claim 9 wherein the first memory bus is used for controlling a first memory slot, and the second memory bus is used for controlling a second memory slot.

11. The package of claim 9 wherein the first memory bus is used for controlling a first dynamic random access memory, and the second memory bus is used for controlling a second dynamic random access memory.
